(19) United States
(12) Patent Application Publication
(10) Pub. No.: US 2013/0048933 A1
(43) Pub. Date: Feb. 28, 2013

(54) LIVESTOCK FENCE SYSTEM

(71) Applicant: Glen Trush, Georgetown, NY (US)

(72) Inventor: Glen Trush, Georgetown, NY (US)

(21) Appl. No.: 13/216,601

(22) Filed: Aug. 24, 2011

(51) Int. Cl. E04H 17/16; B23P 17/04; E04H 17/20

(52) U.S. Cl. 256/19; 29/428

(57) ABSTRACT

Fence sections suitable for use in livestock enclosures. The sections are constructed of polyethylene tubing that includes a pair of end posts that are interconnected by a plurality of rails. The sections are light weight and ductile and thus more adaptable for use as both panels and gates in portable and permanent livestock enclosures.

### FIELD OF THE INVENTION

This invention relates generally to fence sections for use in livestock handling systems.

### BACKGROUND OF THE INVENTION

More specifically this invention relates to prefabricated lightweight, resilient fence sections that can be integrated into either permanent or portable fence systems that are used to retain livestock within a prescribed working area. The sections have the same basic configuration and can be used as either panels or gates within a given fence system.

The use of prefabricated sections has been known for some time in the prior art. The prior art sections have heretofore been predominantly fabricated of heavy duty steel components suitable for retaining rather large animals such as horses and various types of cattle. One widely employed section configuration involves the use of steel tubing that includes at least two vertical end posts that are interconnected by at least two or more horizontally disposed rails. Vertical stays are often times joined to the rails to provide additional strength and rigidity to section of considerable length.

Steel fence section of this nature, although providing great strength and rigidity, are extremely heavy and thus difficult to handle particularly when employed as gates in either type of fence system. Steel fence sections can corrode rather rapidly when exposed to outdoor weather conditions, even when coated with special materials and must be replaced after relatively short intervals of use. In addition, the inflexibility of these steel sections makes the alignment of mating sections extremely difficult particularly when the fence is erected on a terrain that slopes or has a varying contour.

Steel fence sections, and in particular gates, oftentimes become mired down in soil that contains mud, manure, ice and snow or a combination thereof. The sections, because of their weight and rigidity, are generally very difficult to dislodge from the encapsulating viscous soil and much energy and many man hours can be wasted attempting to free the section when necessary to do so.

Lastly it should be noted that special precautions must be taken when steel gates are integrated into electric fence systems to prevent the electrical wires from touching the gate and thus shortening out the entire system. To this end, electrical fence lines are typically either passed underground beneath the gates in special prepared trenches or alternatively suspended upon poles high above the gate. In either case, the isolation of the electrical wiring from the steel gates considerably raises the cost of constructing and maintaining the fence system.

### SUMMARY OF THE INVENTION

It is therefore a primary object of the present invention to improve livestock fence systems.

A further object of the invention is to improve the utility of panel and gate sections that are employed in portable and permanent livestock enclosures.

Yet a further object of the present invention is to provide panel and gate sections for use in both portable and permanent livestock handling systems that are of lighter weight and have more ductility than the panels and gate sections that are presently in use.

Another object of the present invention is to provide panel and gate sections that are fabricated of a non-conductive material that provide for greater safety when used in electrified livestock enclosures.

These and other objects of the present invention are attained by means of a prefabricated livestock fence sections that are constructed of a lightweight, ductile, highly flexible non-conductive material that can be integrated into either portable or permanent enclosure systems to provide the system with greater adaptability without sacrificing the systems ability to safely retain large animals.

### BRIEF DESCRIPTION OF THE DRAWINGS

For a better understanding of these and other objects of the present invention reference shall be made to the following detailed description of the invention which is to be read in association with the accompanying drawings, wherein:

FIG. 1 is a front view of a panel section that embodies the teachings of the present invention;

FIG. 2 is an end view of the panel section illustrated in FIG. 1;

FIG. 3 is a section taken along lines 3-3 in FIG. 1;

FIG. 4 is a front view similar to that shown in FIG. 1 further illustrating three panel sections connected in series within a portable fence system;

FIG. 5 is an enlarged section view taken through one of the connectors shown in FIG. 4 for co-joining two of the panels together in assembly;

FIG. 6 is a front view of a gate section embodying the teachings of the present invention illustrating the gate mounted in a permanent electrified fence system;

FIG. 7 is an enlarged view illustrating one of the latch assemblies shown in FIG. 6 for securing one end of the gate to a permanent pillar of the fence system; and

FIG. 8 is an enlarged partial view showing the gate illustrated in FIG. 6 in greater detail.

### DETAILED DESCRIPTION OF THE INVENTION

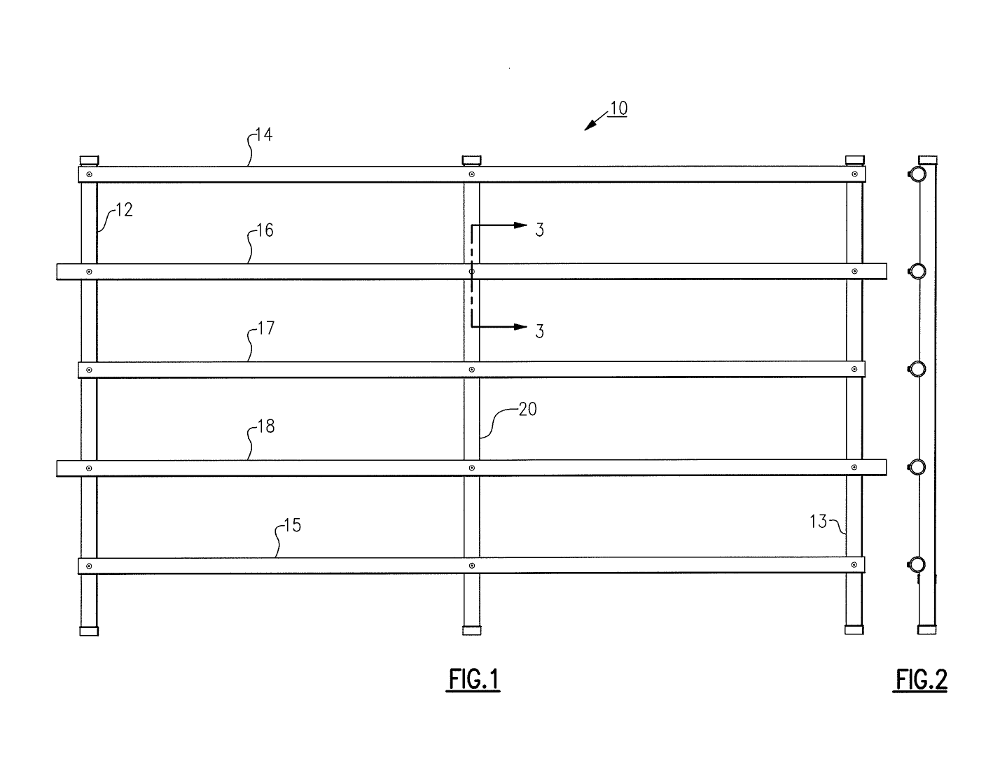

Referring initially to FIGS. 1-3 there is illustrated a fence section generally referenced 10 that embodies the teachings of the present invention. Fence sections of this type are generally constructed of high strength steel are widely employed in livestock handling systems for corralling large animals such as horses and cattle within a specific area for various purposes. These fencing systems take two general forms. The first involves portable systems that contain sections that can be broken down and transported from place to place for reassembly. The second includes permanent systems which are firmly anchored in the ground by pillars.

The fence section illustrated in FIG. 1 is generally referred to as a panel and is configured for use in a portable fencing system. As will be described in further detail below, sections of this configuration can also be adapted for use as gates in both types of fencing systems.

Panel 10 contains two opposed, spaced apart, vertically disposed end posts 12 and 13 of uniform height. The end posts are interconnected in assembly by a plurality of horizontally disposed rails. The rails include an upper rail 14 and a lower rail 15 along with intermediate rails 16-18 that are spaced apart between the upper and lower rails. A vertical stay 20 is centered between the two end posts and is connected to the rails to provide additional support to the overall structure of the panel. The stay in this embodiment has about the same height as the end posts and is in general vertical alignment with the posts. As should become evident from the disclosure below, the number and positioning of stays and rails contained within the panel can vary within specific fence sections without departing from the teachings of the present invention.

The end posts, rails and stays contained within the panel are all fabricated of a thermoplastic tubing with each having the same inside and outside diameters. The tubing is constructed of a polyethylene (PE) material. Applicant has found through testing that high density PE tubing has a number of unique properties that render this material superior to that of steel and other more rigid materials with regard to outdoor livestock fencing.

PE tubing has about one eighth the weight of comparable steel tubing while at the same time having sufficient tensile strength and ductility so that it is able to absorb and withstand high impact loads normally delivered by large animals to livestock fences. PE panels of the type herein described can thus be easily broken down, transported and reassembled by a single normal size man or woman, a task which heretofore oftentimes require more than one person to accomplish.

PE is a visco-elastic material having a time dependent response to loading. Its instantaneous modulus of elasticity is about 150,000 psi. This instantaneous modulus of elasticity provides the PE tubing with both flexibility and ductility. Accordingly, rather large localized loads can be tolerated without producing irreversible damage. The tubing also displays a great deal of flexibility. It can be bent or cold formed by hand in the field to a radius that is about 30 times the nominal diameter of the tubing or somewhat less depending upon the tubes wall thickness. These properties clearly facilitates the installation of panels and gates particularly when connecting parts of the installation do not come together in exact alignment.

Steel on the other hand is a stiff brittle material having a modulus of elasticity of around 28 to 31×10⁶ psi and cannot be hand worked in the field to correct for any misalignment of part or the like. The low modulus of elasticity of PE sections also permits panels and gates constructed as noted above to self conform to the contour of the ground upon which the fence is erected thus providing for a more stable construction and one that is esthetically more pleasing when compared to more rigid structures. Gates made of PE that are situated upon irregular or hilly ground can generally be hand deformed sufficiently to pass over ground obstructions that would normally prevent proper opening and closing of a steel gate.

Panels and gates made of PE are also impervious to harsh weather conditions and exhibit a long life requiring little or no maintenance. Steel gates and panels on the other hand tend to corrode rather rapidly when exposed to the elements and must be replaced at rather short intervals.

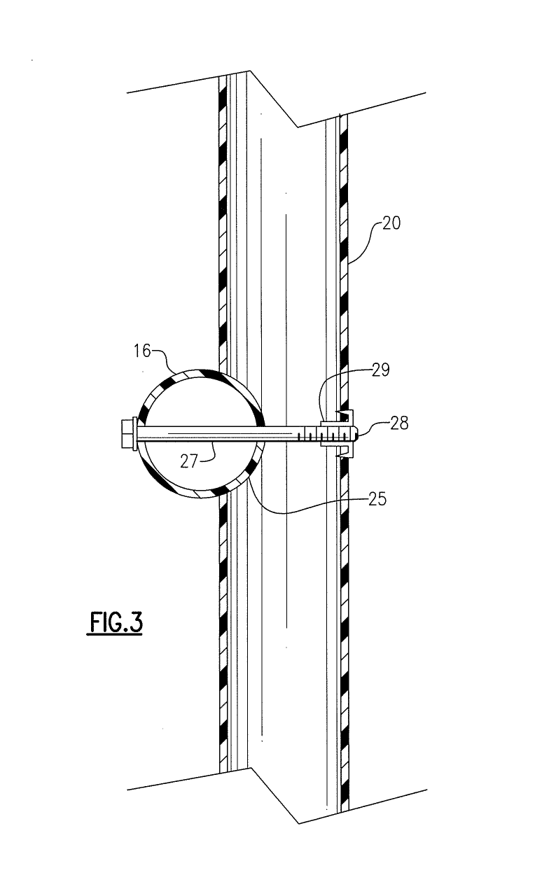

As best illustrated in FIG. 3, each of the end post and stay members embodied in panel 10 contains a series of vertically spaced apart seats 25 that are cut or otherwise impressed into the members for registering and helping to support the rails in assembly. As noted above the rails are cylindrical tubes. The seats are semi-circular in form having a radius that is about equal to the outer radius of the tubes to allow the rails to be snuggly mounted within the seats. A threaded bolt 27 is used to secure the rails within the seats. The bolt is passed through the rail and the rear of a supporting post or stay and a lock nut 29 is mated to the threaded end 28 of the bolt. When tightened down the bolt serves to securely hold the rail within the seat. With the rails secured tightly to the end posts, any input load, whether localized or otherwise that is imparted to a panel or a gate having this construction will be absorbed by the entire panel or gate structure regardless of the direction of the load.

It should be evident that other means may be employed to secure the rails within the seats. PE tubing can be fusion welded to create joins that are of greater strength that the tube itself. Accordingly, a fusion weld joint running between the rail and seat can be similarly used to securely hold the rails within the seats and thus creating an extremely strong fence section.

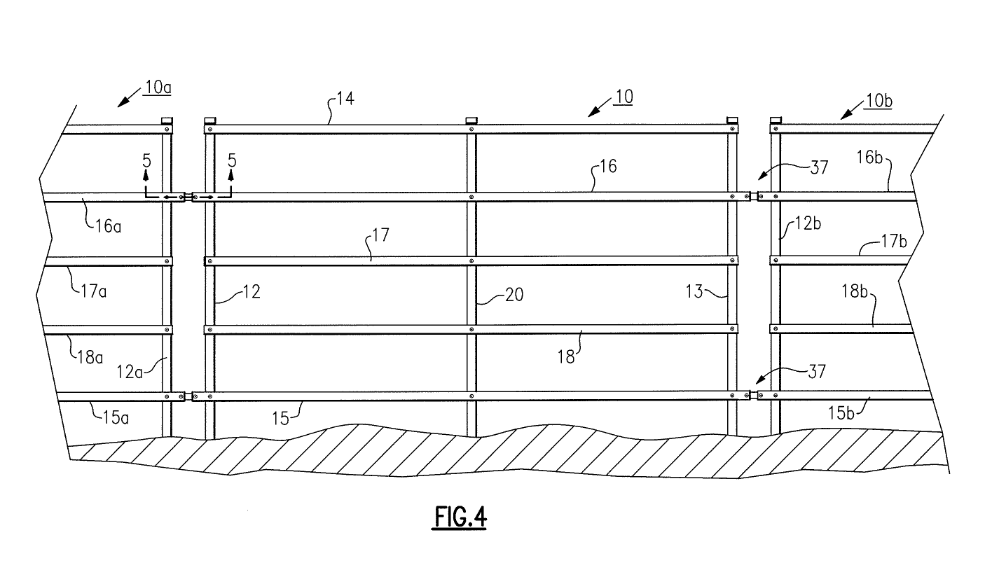

Turning now to FIG. 4, there is illustrated a portion of a portable fence showing three panels co-joined in series. The center panel is referenced 10 while the two side panels are reference 10a and 10b, respectively. Each panel is removably attached to its neighbor by means of a pair of connectors generally referenced 37. The geometry of the connectors is more clearly shown in enlarged FIG. 5. Two of the horizontal rails in each panel are extended beyond the two end posts of the panel and, in assembly, are axially aligned with two similarly extended rails in a neighboring panel. To this end rails 15 and 16 of the central panel are extended and axially aligned with extended rails 15a and 15b and 16a and 16b in the neighboring panels. As illustrated in FIG. 5, a connector pin 38 having a close running fit with the inside diameter of the two axially aligned rails is slip fitted into the two adjacent rails and the rail ends are brought closely together. A pair of spaced apart clearance holes 39-39 are formed within the connector pin 38 and are brought into registration with similar holes located in each of the adjacent rail ends. A locking pin 40 is placed within the registered holes which secures the connector in a locked position. Because of the flexibility of the adjacent panels any misalignment between the mating parts of the connector can be corrected by simply hand adjusting the positioning of the misaligned components in assembly.

Turning now to FIGS. 6-8, there is illustrated a gate generally referenced 50 that is constructed of polyethylene tubing in the same manner as gate 10 shown in FIG. 1. Gate 50 includes a pair of opposed vertical end posts 51 and 52 that are interconnected by means of four horizontal rails 53-56. The gate is of considerable length and further includes three vertical stays 58-60 that are equally spaced over the length of gate to provide additional support. The rails are registered within seats as described above that are impressed within the end posts and stays. The rails are secured to the end posts and stays by threaded fasteners, however, as noted above, other suitable fastening means may be employed.

FIG. 6 shows the gate positioned between a pair of vertical pillars 62 and 63 that are anchored securely in the ground. The pillars are part of an electrical fence system of well known construction that includes four electrical lines 65-68 that are strung between similar pillars to create a livestock enclosure. Although not shown, the wires are attached to a source of power of sufficient voltage to cause any animal that might come in contact with one of the wires to be shocked.

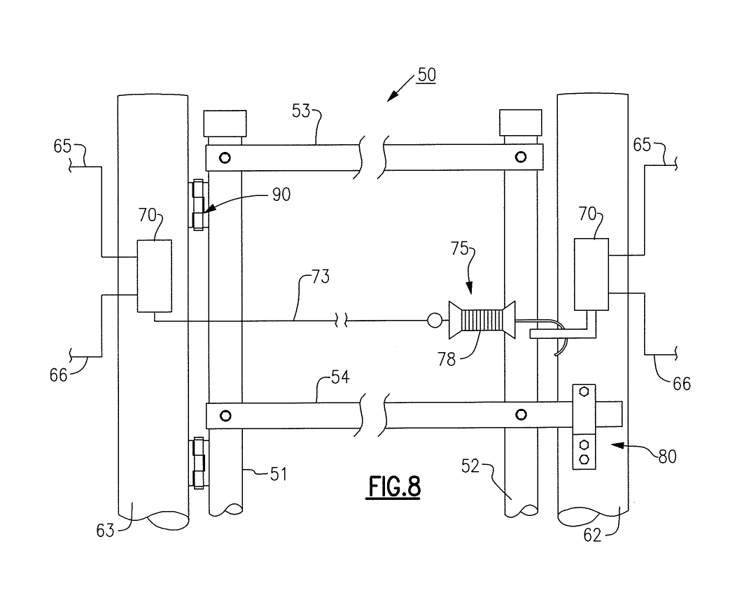

With further reference to FIG. 8, a pair of terminal boxes are secured to each of the pillars which include two upper positioned terminal boxes 70-70 and two lower positioned terminal boxes 71-71. Two of the fence lines 65 and 66 are tied into the upper boxes while the remaining two fence lines 67 and 68 are tied into the two lower boxes. In addition, an electrical cable 73 is strung tautly across the gate between the two upper terminal boxes while a second cable 74 is similarly strung across the gate to connect the two lower terminal boxes thus closing the electrical loop of the enclosure system.

As best shown in FIG. 8, each of the cables 72 and 73 connecting the terminal boxes is provided with a non-conductive sleeve assembly 75 at one end adjacent to pillar 62. Each sleeve 78 is secured to a hook shaped cable end member that is arranged to engage a terminal upon an adjacent terminal box to permit the cable to be easily detached from the terminal box.

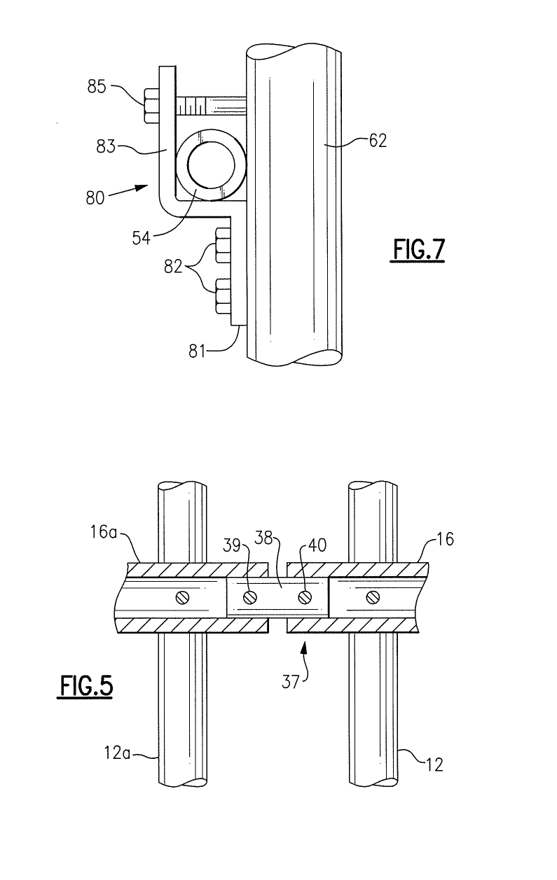

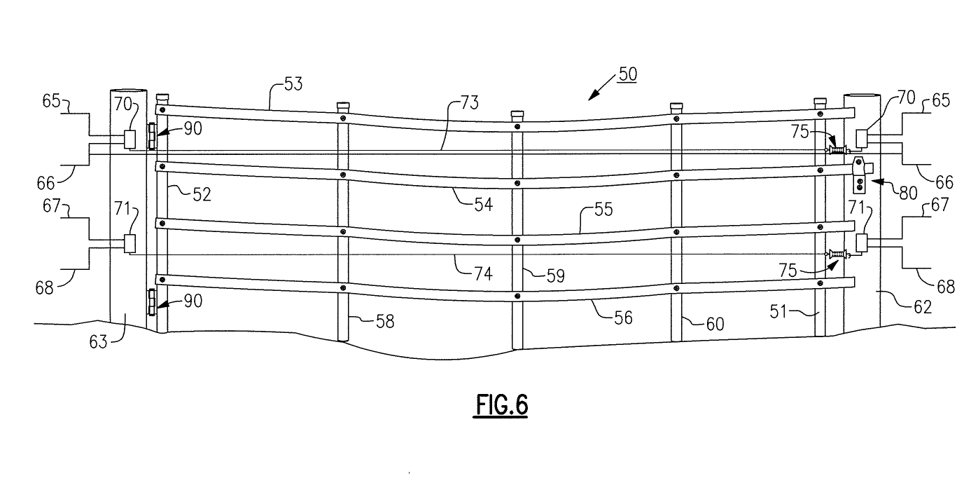

As illustrated in FIG. 7, rail 54 of the gate extends beyond end post 52 and engages a latching bracket, generally references 80 secured to the adjacent pillar 62 when the gate is in a closed position. The bracket has a vertical flange 81 that is secure to the pillar by a pair of mounting bolts 82. An L-shaped upper section 83 is integral with the flange and is arranged to receive therein the extended portion of rail 54. A bolt 85 is threaded into the raised arm of the L-shaped section which when threaded into contact with the pillar prevent the rail 54 from being dislodged from the bracket.

End post 51 of the gate is brought in parallel alignment with pillar 63 and is pivotably connected to the pillar 63 by a pair of hinges 90-90. To open the gate, cables 73 and 74 are first detached from terminal boxes 70 and 71 and the bolt holding rail 54 in latching bracket 80 is removed to free the rail from the pillar. The gate, because it is constructed of a ductile polyethylene has sufficient flexibility so that it can be easily lifted free of the latching bracket and swung to an open position. The closed gate shown in FIG. 6 is situated upon an uneven parcel of ground. Again, because of its flexibility, the gate under its own weight will sag slightly along its length to more or less follow the terrain.

Panels of the type illustrated in FIG. 1 can be rapidly adapted to act as gates in portable fence systems. This is readily accomplished by mounting one or more latching brackets 80 as shown in FIG. 7 on two panels neighboring the intended gate such that one or more gate rails can be dropped into the latches thus securing the gate in a closed position. Because the polyethylene gate is relatively light and flexible it can be easily lifted out of the brackets and moved out of the gate opening thus opening the gate passageway.

Extended testing of livestock enclosures containing both panels and gates constructed of high density polyethylene tubing clearly showed that these sections were able to continuously withstand high impact loads generated by large bulls and cows without any indication of failure. The tubing used in these tests was standard 2.0 inch I.D tubing having a density greater than 0.940. These tests further showed that these panels and gates, because of their flexibility, could be easily removed from entrapping viscous soil by simply working the sections back and forth until released by the soil.

While the invention has been described with reference to preferred embodiments, it will be understood by those skilled in the art that various changes may be made and equivalents may be substituted for elements thereof to adapt to particular situations without departing from the scope of the invention. Therefore, it is intended that the invention not be limited to the particular embodiments disclosed as the best mode contemplated for carrying out this invention, but that the invention will include all embodiments falling within the scope and spirit of the appended claims.

1. A fence section suitable for use in a livestock enclosure system as either a panel or gate that includes:
a pair of opposed vertically disposed end posts;
at least two horizontally disposed rails interconnected with said end posts;
each of said end posts and said rails being fabricated of a polyethylene tubing; and
fastening means for securing said rails to said posts.

2. The fence section of claim 1, wherein said end posts and rails have a density greater than 0.940.

3. The fence section of claim 2, wherein said polyethylene tubing has a instantaneous modulus of elasticity of about 150,000 psi.

4. The fence section of claim 3, wherein said end posts each contain a series of vertically aligned seats impressed therein that are equal in number to the number of rails for registering said rails in parallel alignment.

5. The fence section of claim 4, wherein said rails are secured in said seats by threaded fasteners.

6. The fence section of claim 4, wherein said rails are secured in said seats by fusion weld joints running between said rails and end posts.

7. A method of erecting a livestock enclosure that includes the steps of:
providing a polyethylene tubing;
forming said tubing into sections each section containing a pair of vertical end posts that are interconnected by a plurality of horizontal rails; and
connecting said sections in series to establish an enclosure.

8. The method of claim 7, wherein said tubing has a instantaneous modulus of elasticity of about 150,000 psi.

9. The method of claim 8, that includes the further step of elongating at least one of the rails of a section beyond said end posts; and
removably hanging the extended ends of said at least one rail in brackets contained in two neighboring sections of said one section to establish a gate.

10. The method of claim 8, that includes the further step of impressing a series of spaced apart seats in each of said end posts for registering said rails within said end posts.

11. A method of mounting a gate within a fence system having electrified wiring for enclosing livestock, said method including the steps of:
providing a pair of opposed upright pillars;
mounting at least one electrical terminal upon each of said pillars;
connecting said at least one terminal into said electrified wiring of said fence system;
positioning a gate fabricated of a non-conductive polyethylene tubing between said pillars;
attaching said gate to said pillars so that said gate can be moved between an open position and a closed position;
stringing an electrical cable tautly across said non-conductive gate between said terminals when said gate is in a closed position; and
removably connecting one end of said electrical cable to one of said terminals so that said electrical cable can be detached from said one terminal to allow the gate to be moved to an open position.
